(19) United States
(12) Patent Application Publication
(10) Pub. No.: US 2026/0010592 A1
(43) Pub. Date: Jan. 8, 2026

(54) RELATIONSHIP-BASED ACCESS CONTROL AUTHORIZATION MODEL QUERY GENERATION

(71) Applicant: OKTA, INC., SAN FRANCISCO, CA (US)

(72) Inventor: Jonathan Bennion WHITAKER, Salt Lake City, UT (US)

(21) Appl. No.: 18/763,627

(22) Filed: Jul. 3, 2024

(51) Int. Cl. G06F 21/31; G06F 21/60

(52) U.S. Cl. CPC G06F 21/31; G06F 21/604

(57) ABSTRACT

An identity and access management system may utilize a relationship-based authorization system for indexing permission relationships. To index the permission relationships, the relationship-based authorization system may receive, from a developer, an authorization model for a data management system where the authorization model indicates a set of users and a set of objects. An identification system associated with the relationship-based authorization system may identify a set of relations associated with a set of relationship tuples indicated within the authorization model. Moreover, a respective relationship tuple may indicate an authorization level of a respective user for a respective object. Further, a message generation system associated with the relationship-based authorization system may generate a set of data messages associated with the set of relationship tuples. The results of the set of data messages may be used to obtain a set of indices used for authorizing access to data within the data management system.

### FIELD OF TECHNOLOGY

The present disclosure relates generally to identity and access management, and more specifically to relationship-based access control authorization model query generation.

### BACKGROUND

An identity and access management (IAM) system may be employed to manage and store various forms of user data, including usernames, passwords, email addresses, permissions, roles, group memberships, etc. The IAM system may provide authentication and authorization services for applications, devices, users, and the like. The IAM system may enable organizations to manage and control access to resources, for example, by serving as a central repository that integrates with various identity and access policy sources. The IAM system may provide an interface that enables users to access a multitude of applications with a single set of credentials.

Some IAM systems may utilize fine-grained authorization (FGA) systems to authorize users. In some examples, an FGA system may grant one or more users with a set of permissions to perform a set of actions. In some other examples, if an IAM system and the associated FGA system are associated with a relatively large quantity of users with different permissions, the FGA system may implement a relationship-based access control (ReBAC) model. In a ReBAC model, users may be granted access based on relationships between the users and respective objects within a data management system. However, determining permissions for users or clients querying a data management system that is associated with an IAM system utilizing a ReBAC model may be relatively difficult due a relatively large quantity of relationships between the users and the objects of the data management system.

### SUMMARY

A method for indexing permission relationships in a relationship-based authorization system by an apparatus is described. The method may include receiving, from a developer of the relationship-based authorization system, an authorization model from a data management system, the authorization model indicating a set of users and a set of objects, identifying, via an identification system, a set of relations indicating relationships within the authorization model between the set of users and the set of objects, the set of relations corresponding to a set of relationship tuples, where a respective relationship tuple indicates an authorization level of a respective user for a respective object, and generating, via a message generation system, a set of data messages that are associated of the set of relationship tuples indicated within the authorization model, the set of data messages being generated to obtain a set of indices that indicate results of the set of data messages, where the set of indices are for authorizing access to data within the data management system.

An apparatus for indexing permission relationships in a relationship-based authorization system is described. The apparatus may include one or more memories storing processor executable code, and one or more processors coupled with the one or more memories. The one or more processors may individually or collectively be operable to execute the processor-executable code to cause the apparatus to receive, from a developer of the relationship-based authorization system, an authorization model from a data management system, the authorization model indicating a set of users and a set of objects, identify, via an identification system, a set of relations indicating relationships within the authorization model between the set of users and the set of objects, the set of relations corresponding to a set of relationship tuples, where a respective relationship tuple indicates an authorization level of a respective user for a respective object, and generate, via a message generation system, a set of data messages that are associated of the set of relationship tuples indicated within the authorization model, the set of data messages being generated to obtain a set of indices that indicate results of the set of data messages, where the set of indices are for authorizing access to data within the data management system.

Another apparatus for indexing permission relationships in a relationship-based authorization system is described. The apparatus may include means for receiving, from a developer of the relationship-based authorization system, an authorization model from a data management system, the authorization model indicating a set of users and a set of objects, means for identifying, via an identification system, a set of relations indicating relationships within the authorization model between the set of users and the set of objects, the set of relations corresponding to a set of relationship tuples, where a respective relationship tuple indicates an authorization level of a respective user for a respective object, and means for generating, via a message generation system, a set of data messages that are associated of the set of relationship tuples indicated within the authorization model, the set of data messages being generated to obtain a set of indices that indicate results of the set of data messages, where the set of indices are for authorizing access to data within the data management system.

A non-transitory computer-readable medium storing code for indexing permission relationships in a relationship-based authorization system is described. The code may include instructions executable by one or more processors to receive, from a developer of the relationship-based authorization system, an authorization model from a data management system, the authorization model indicating a set of users and a set of objects, identify, via an identification system, a set of relations indicating relationships within the authorization model between the set of users and the set of objects, the set of relations corresponding to a set of relationship tuples, where a respective relationship tuple indicates an authorization level of a respective user for a respective object, and generate, via a message generation system, a set of data messages that are associated of the set of relationship tuples indicated within the authorization model, the set of data messages being generated to obtain a set of indices that indicate results of the set of data messages, where the set of indices are for authorizing access to data within the data management system.

Some examples of the method, apparatus, and non-transitory computer-readable medium described herein may further include operations, features, means, or instructions for receiving, from a client, a natural language query, the natural language query indicating a request for a user associated with the client to access one or more objects of the set of objects that may be stored within the data management system based on the set of relations indicated within the authorization model, authorizing the client to obtain a subset of objects of the set of objects associated with the request that the user may be authorized to access based on the set of indices generated via the message generation system, the user being authorized to access a respective object of the set of objects that may be associated with the request based on at least one index of the set of indices indicating that the user may have a relationship with the respective object, and transmitting, to the client, the subset of objects associated with the request of the natural language query that the user may be authorized to access based on one or more relationships between the user and the subset of objects that the user may be authorized to access.

Some examples of the method, apparatus, and non-transitory computer-readable medium described herein may further include operations, features, means, or instructions for transmitting, via an application programming interface associated with the set of indices used for authorizing access within the data management system, a message requesting for an indication of the subset of objects associated with the request of the natural language query and receiving, via the application programming interface, the subset of objects associated with the request based on the user having a relationship with each object of the subset of objects, where the subset of objects transmitted to the client based on receiving the subset of objects via the application programming interface.

Some examples of the method, apparatus, and non-transitory computer-readable medium described herein may further include operations, features, means, or instructions for receiving an update to the data management system, the update including adding one or more objects, removing one or more objects, or both and updating, via the message generation system, the set of indices based on receiving the update to the data management system.

Some examples of the method, apparatus, and non-transitory computer-readable medium described herein may further include operations, features, means, or instructions for receiving an update to the authorization model, the update including an addition of one or more users, one or more objects, one or more relations relating users and objects, or any combination thereof, a removal of one or more users, one or more objects, one or more relations relating users and objects, or any combination thereof, or both and updating, via the message generation system, the set of data messages and the set of indices based on receiving the update to the authorization model.

In some examples of the method, apparatus, and non-transitory computer-readable medium described herein, receiving the authorization model may include operations, features, means, or instructions for receiving, from a first tenant of a multi-tenant system, a first authorization model for the data management system, the first authorization model indicating information for authorizing users associated with the first tenant to access one or more objects within the data management system that may be associated with the first tenant, where the data management system may be accessible by one or more tenants of the multi-tenant system, and where the first authorization model includes the authorization model.

In some examples of the method, apparatus, and non-transitory computer-readable medium described herein, the set of data messages may include a set of data queries, and the method, apparatuses, and non-transitory computer-readable medium may include further operations, features, means, or instructions for obtaining the set of indices used for authorizing access to the data within the data management system based on one or more data query operations on the set of data queries, the one or more data query operations combining the set of data queries.

In some examples of the method, apparatus, and non-transitory computer-readable medium described herein, a respective index of the set of indices indicates a direct relationship between a respective user and a respective object, a computed relationship between the respective user and the respective object, a nested relationship between the respective user and the respective object, a hierarchical relationship between the respective user and the respective object, or any combination thereof.

In some examples of the method, apparatus, and non-transitory computer-readable medium described herein, the set of data messages may be structured query language (SQL) queries.

In some examples of the method, apparatus, and non-transitory computer-readable medium described herein, the authorization model may be a fine-grained authorization model that may be defined via a domain-specific language.

### BRIEF DESCRIPTION OF THE DRAWINGS

FIGs. 1 and 2 illustrate examples of a computing system that supports relationship-based access control authorization model query generation in accordance with aspects of the present disclosure.

FIG. 3 shows an example of an authorization model diagram that supports relationship-based access control authorization model query generation in accordance with aspects of the present disclosure.

FIG. 4 shows an example of a process flow that supports relationship-based access control authorization model query generation in accordance with aspects of the present disclosure.

FIG. 5 shows a block diagram of an apparatus that supports relationship-based access control authorization model query generation in accordance with aspects of the present disclosure.

FIG. 6 shows a block diagram of a relationship index generator that supports relationship-based access control authorization model query generation in accordance with aspects of the present disclosure.

FIG. 7 shows a diagram of a system including a device that supports relationship-based access control authorization model query generation in accordance with aspects of the present disclosure.

FIG. 8 shows a flowchart illustrating methods that support relationship-based access control authorization model query generation in accordance with aspects of the present disclosure.

### DETAILED DESCRIPTION

In some examples, an identity and access management (IAM) system may utilize a fine-grained authorization (FGA) system to authorize users’access to one or more objects within a data management system. In some cases, the FGA system may grant users, having a set of permissions, to perform a set of actions. In some other cases, the FGA system may implement a relationship-based access control (ReBAC) system to grant users access based on relationships a user has with respective objects. For example, a user may be granted access to a document based on a relationship with the folder the document is stored in. Therefore, developer and administrative users may implement a ReBAC model by outlining a set of relationships rather than indicating specific permissions for each user of a system.

However, when using a ReBAC system with a relatively large quantity of users, determining permissions may be relatively time consuming and complex. For example, a client may search for a set of objects stored in a data management system (e.g., a database) associated with one or more parameters (e.g., a keyword). Prior to presenting the client with a display of all the objects within the data management system, a relationship-based authorization system (e.g., a type of IAM system) may have to determine which objects the client may be capable of accessing (e.g., which objects the client may have a relationship with).

To reduce the complexity and time-consumption of searching a system using a ReBAC model for authorization, a set of indices may be generated to indicate the various relationships between users and objects. For example, a developer of a relationship-based authorization system may generate and provide an authorization model for a data management system (e.g., a database). The authorization model may indicate a set of users, a set of objects, and a set of relations between the set of users and the set of objects. An identification system of the relationship-based authorization system may then identify a set of relationship tuples indicated within the provided authorization model. Moreover, a respective relationship tuple may indicate a level of authorization for a respective user to access a respective object. For example, a first relationship tuple may indicate that a user is a group member of a first group, and a second relationship tuple may indicate that group members of the first group may have editing access of a respective document.

Further, a message generation system of the relationship-based authorization system may generate a set of data messages associated with the set of relationship tuples to obtain indices that indicate the results of the set of data messages. For example, respective data messages may query the data management system to obtain an index of users associated with a respective relationship tuple. Thus, the set of indices may be used for authorizing clients access to data within the data management system. Using the set of indices, the relationship-based authorization system may be capable of determining a level of access or authorization for a user or client more efficiently by searching the indices rather than checking the individual relationships. Therefore, the set of indices may reduce the complexity and time consumption associated with determining whether a user or client has access to a respective object.

In some examples, clients may search for one or more objects within a data management system based on a keyword. For example, the relationship-based authorization system may receive a natural language query from a client requesting for a list of objects (e.g., a list of objects associated with a set of criteria such as one or more key words). The relationship-based authorization system may then use the set of indices to determine which objects the client is authorized to access. Based on the authorization, a list of objects that the client is authorized to access may be transmitted to the client for display in response to the natural language query. Moreover, in some cases, the set of data messages used to obtain the set of indices may be structured query language (SQL) queries. For example, a respective SQL query may query the data management system for each user associated with a respective condition to generate an index of users associated with the respective condition. In some examples, the relationship-based authorization system may further perform one or more data query operations on the set of data messages (e.g., SQL query operations on SQL queries) to obtain the indices.

Using such techniques of the present disclosure, determining access to objects being searched by a user may be relatively less complex and time-consuming. For example, if a client performs a search within a data management system that includes a set of criteria, the relationship-based authorization system may use the set of indices to determine a set of objects that both match the set of criteria of the search and that are accessible to the client. By using the set of indices, the relationship-based authorization system may be capable of reducing the time-consumption of searches by reducing the time-consumption associated with determining whether a client is authorized to access a respective object. Therefore, searching the data management system may be relatively more efficient and reliable due to the decrease in latency.

Aspects of the disclosure are initially described in the context of a computing system. Additional aspects of the disclosure are described with reference to a computing system, an authorization model diagram, and a process flow. Aspects of the disclosure are further illustrated by and described with reference to apparatus diagrams, system diagrams, and flowcharts that relate to relationship-based access control authorization model query generation.

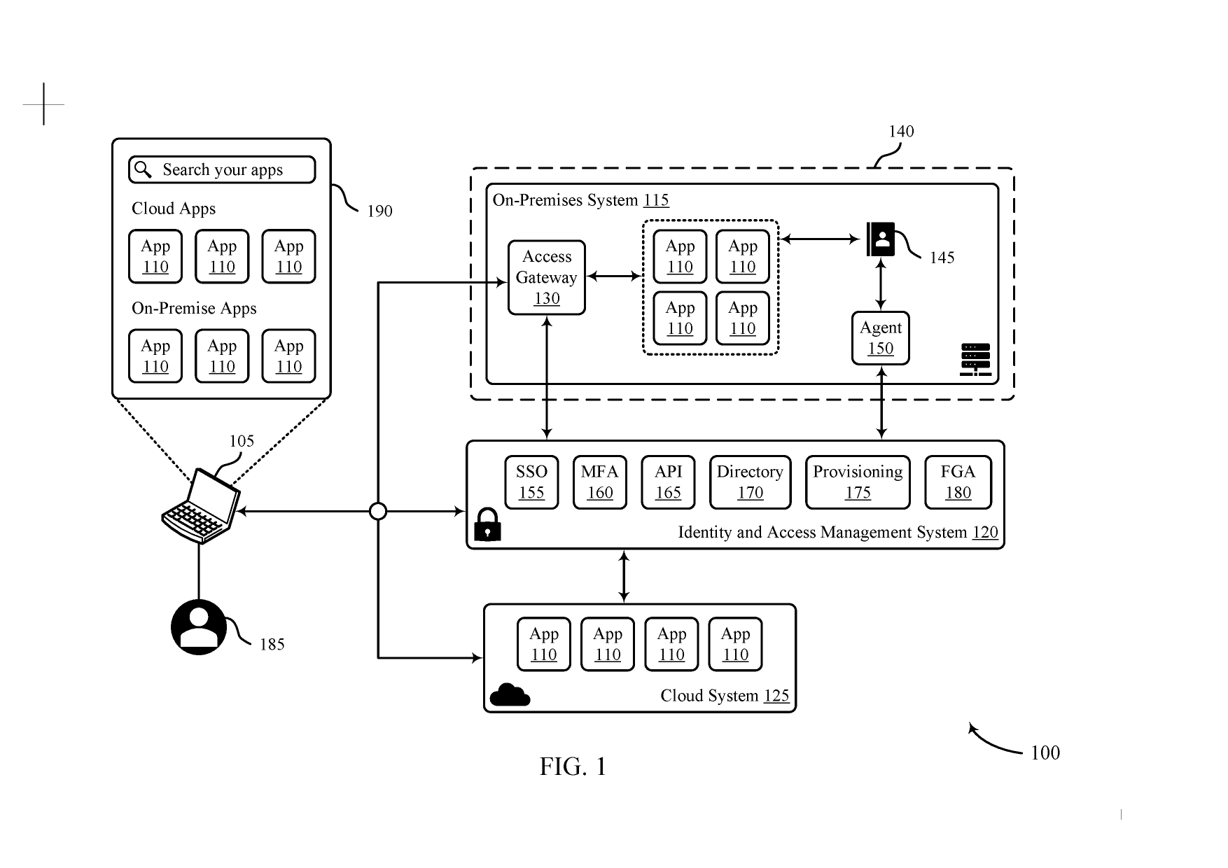

FIG. 1 illustrates an example of a computing system 100 that supports relationship-based access control authorization model query generation in accordance with various aspects of the present disclosure. The computing system 100 includes a computing device 105 (such as a desktop, laptop, smartphone, tablet, or the like), an on-premises system 115, an IAM system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The IAM system 120 may support one or more services, such as a single sign-on (SSO) service 155, a multi-factor authentication (MFA) service 160, an application programming interface (API) service 165, a directory management service 170, a provisioning service 175 for various on-premises applications 110 (e.g., applications 110 running on compute resources of the on-premises system 115), an FGA service 180, and/or cloud applications 110 (e.g., applications 110 running on compute resources of the cloud system 125), among other examples of services. The SSO service 155, the MFA service 160, the API service 165, the directory management service 170, the provisioning service 175, and/or the FGA service 180 may be individually or collectively provided (e.g., hosted) by one or more physical machines, virtual machines, physical servers, virtual (e.g., cloud) servers, data centers, or other compute resources managed by or otherwise accessible to the IAM system 120.

A user 185 may interact with the computing device 105 to communicate with one or more of the on-premises system 115, the IAM system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the IAM system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the IAM system 120 may allow the user 185 to access multiple applications 110 with one or more credentials. Once authenticated, the user 185 may access one or more of the applications 110 (for example, via the interface 190 of the computing device 105). That is, based on the IAM system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the IAM system 120, which may serve as the identity provider (IdP). For example, in some implementations, the browser (e.g., the user’s request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user’s request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user’s identity by comparing the credentials provided by the user 185 to credentials associated with the user’s account. For example, one or more credentials associated with the user’s account may be registered with the IdP (e.g., previously registered, or otherwise authorized for authentication of the user’s identity via the IdP). The IdP may generate a security token (such as a SAML token or Oauth 2.0 token) containing information associated with the identity and/or authentication status of the user 185 based on successful authentication of the user’s identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the IAM system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the IAM system 120 in accordance with an SSO flow and, in response, the IAM system 120 may prompt the user 185 to provide a second factor, such as a possession factor (e.g., a one-time passcode (OTP), a hardware token, a text message code, an email link/code). The user 185 may obtain access (e.g., be granted access by the IAM system 120) to the requested applications 110 based on successful verification of both the first authentication factor and the second authentication factor.

The API service 165 of the IAM system 120 can secure APIs by managing access tokens and API keys for various client organizations, which may enable (e.g., only enable) authorized applications (e.g., one or more of the applications 110) and authorized users (e.g., the user 185) to interact with a client organization’s APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

In some examples, the API service 165 may be used to transmit one or more APIs that can be examples of computer programs that establish interfaces between two or more applications, services, servers, computing devices, or any combination thereof. An API may further describe and indicate how applications should perform requests and respond to requests. For example, an API associated with a first application may indicate how other applications may request data from the first application and how the first application may respond to such requests. In some examples, a request via an API may be referred to as an API request or an API call elsewhere herein. In another example, a computing device may perform an API call or API request to a server to receive information from the server. In some cases, to ensure that the user of the computing device, the computing device, or both, has access to the data being requested, the server may perform an API call or request to a separate API service with another server or service associated with authentication (e.g., an authentication server, an authentication platform, an authentication service, or any combination thereof). In response, the server may receive an API response indicating whether the user of the computing device, the computing device, or both are capable of accessing the requested data. If the user of the computing device, the computing device, or both are capable of accessing the requested data, the API response from the server may include the corresponding data, otherwise the API response may indicate that the user of the computing device, the computing device, or both are incapable of accessing the requested data. Additionally, or alternatively, API calls or requests may be made to endpoints or locations (e.g., API endpoints) that are indicated as a designated location for a request to be fulfilled.

The directory management service 170 may enable the IAM system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the IAM system 120).

The provisioning service 175 of the identity and access management system 120 may support user provisioning and deprovisioning. For example, in response to an employee joining a client organization, the IAM system 120 may automatically create accounts for the employee and provide the employee with access to one or more resources via the accounts. Similarly, in response to the employee (or some other employee) leaving the client organization, the IAM system 120 may autonomously deprovision the employee’s accounts and revoke the employee’s access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the IAM system 120 and connected applications 110, ensuring that user profiles are consistent across the IAM system 120, the on-premises system 115, and the cloud system 125.

The FGA service 180 may enable the IAM system 120 to provide users 185 with a ReBAC model to grant the users 185 access to the one or more applications 110 and/or other services. For example, a relationship-based authorization system associated with the FGA service 180 of the IAM system 120 may utilize the ReBAC model for authorizing users 185 access to data stored within a data management system. In some cases, the data management system may be hosted within the cloud system 125 or may be hosted at a server associated with the on-premises system 115. A ReBAC model may be defined via an authorization model that a user 185 (e.g., a developer or administrator) may provide to the relationship-based authorization system. The authorization model may indicate one or more users, one or more objects, and one or more relationship tuples. The one or more relationship tuples may be used to indicate whether a relationship exists between a respective user and a respective object and can be identified via an identification system of the relationship-based authorization system. Using a message generation system of the relationship-based authorization system, the relationship-based authorization system may generate a set of data messages for the one or more relationship tuples of the authorization model. The set of data messages may then be used to obtain a set of indices associated with the one or more relationship tuples. For example, the relationship-based authorization system may generate a set of SQL queries to query the data management system for an index of users associated with each relationship tuple.

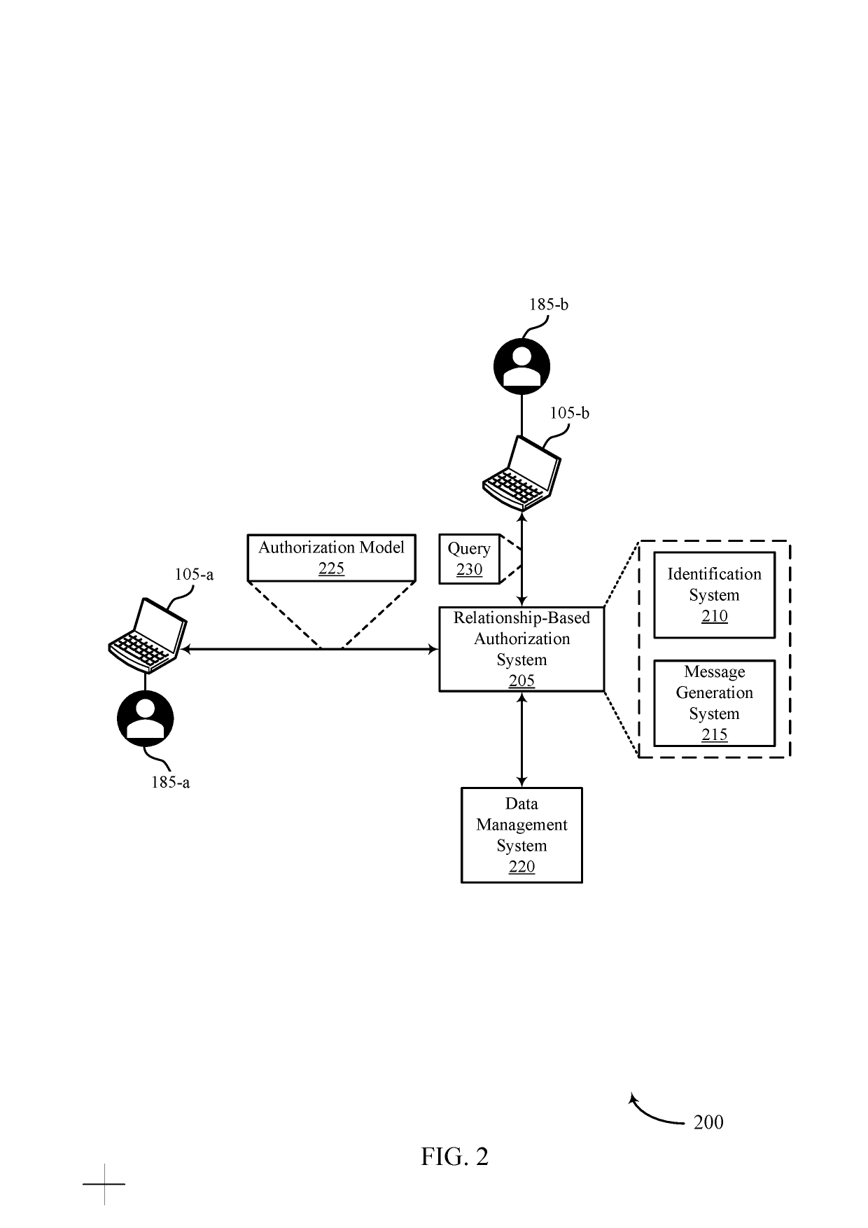

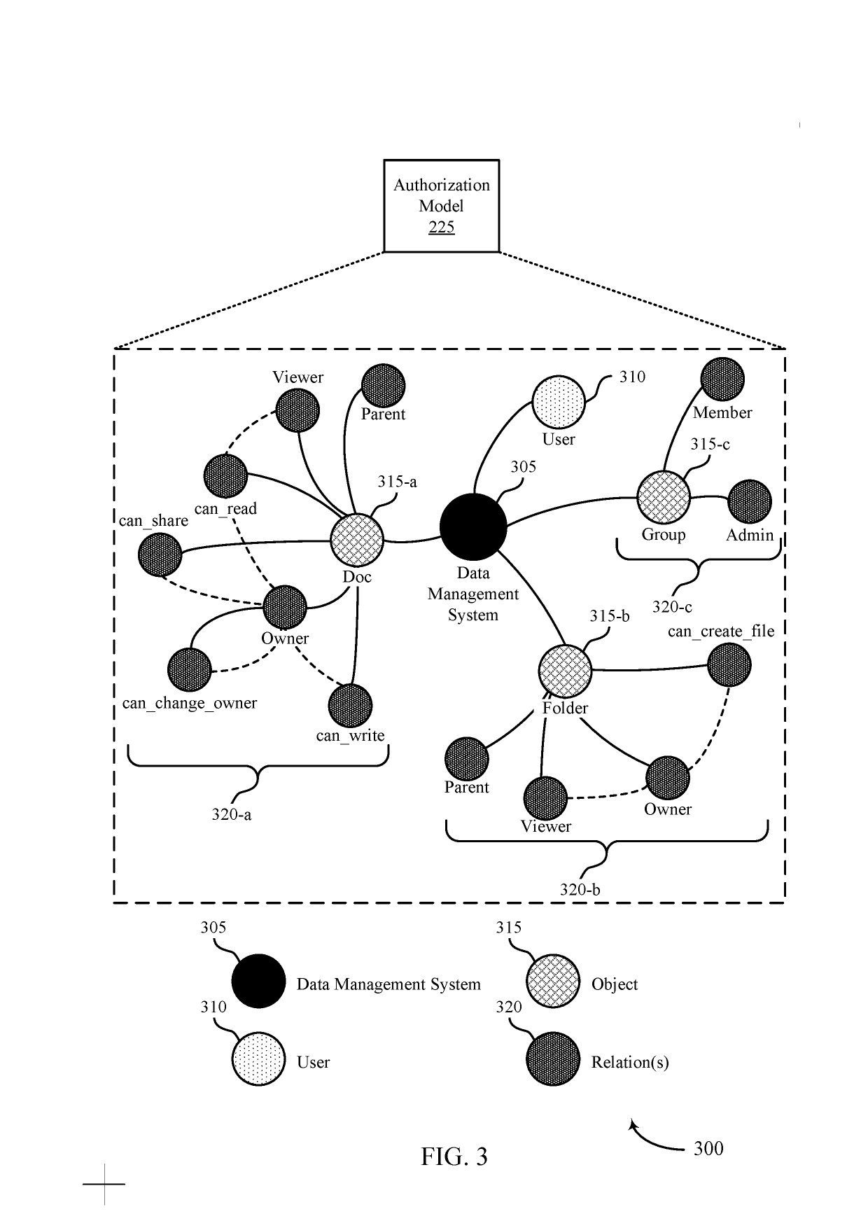

In accordance with the techniques of the present disclosure, the relationship-based authorization system associated with the FGA service 180 may use the set of indices to reduce the complexity and time-consumption of determining whether a user 185 has access to objects within the data management system. For example, to determine access levels, the relationship-based authorization system may be capable of querying the set of indices rather than the entire authorization model, thus reducing the latency associated with determining if a user can access an object. Thus, in accordance with the techniques of the present disclosure, the generation and use of the set of indices associated with the identified relationships of an authorization model may increase the efficiency and reliability of users 185 searching for objects within a data management system. Further descriptions of the techniques of the present disclosure may be described elsewhere herein, such as with reference to FIGs. 2 and 3.

Although not depicted in the example of FIG. 1, a person skilled in the art would appreciate that the IAM system 120 may support or otherwise provide access to any number of additional or alternative services, applications 110, platforms, providers, or the like. In other words, the functionality of the IAM system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

FIG. 2 shows an example of a computing system 200 that supports relationship-based access control authorization model query generation in accordance with aspects of the present disclosure. In some examples, the computing system 200 may be implemented by or may implement the computing system 100. For example, the computing system 200 may include a user 185-a of a computing device 105-a and a user 185-b of a computing device 105-b, both of which may communicate with a relationship-based authorization system 205 that is associated with an IAM system 120, which may be examples of devices and services described with reference to FIG. 1. Further, the relationship-based authorization system 205 may include an identification system 210 and a message generation system 215. Moreover, the relationship-based authorization system 205 may be used for authorizing users access to data stored within a data management system 220. The data management system 220 may be hosted locally on a server device, a cloud-based system, or a combination thereof and may be an example of a database, a collaborative file management system, or any other type of system that stores one or more objects accessible to a set of users 185.

In some examples, to establish relationships between one or more users 185 and one or more objects of a data management system 220, the user 185-a (e.g., a developer or administrator) of a computing device 105-a may configure an authorization model 225. In some cases, the authorization model 225 may be an example of a ReBAC model as described elsewhere herein such that the authorization model 225 includes one or more definitions for different types. Moreover, together with a set of relationship tuples that indicate direct relationships between a user 185 and an object, the relationship-based authorization system 205 may use the authorization model 225 to determine whether a relationship exists between a respective user 185 and a respective object stored within the data management system 220.

Based on the user 185-a developing or establishing the authorization model 225, the user 185-a may transmit or send the authorization model 225 to a relationship-based authorization system 205. The relationship-based authorization system 205 may use the authorization model 225 to respond to queries 230 from the user 185-b of the computing device 105-b. For example, the user 185-b may query the relationship-based authorization system 205 for access to a set of objects within the data management system 220 that are associated with one or more keywords. In response, the relationship-based authorization system 205 may use the authorization model 225 to determine which objects that are stored within the data management system 220 the user 185-b is able to access based on the relationships defined for the user 185-b within the authorization model 225.

In some cases, the query 230 may be in the form of a search. Further, the query 230 may be a natural language query where the user 185-b is searching for objects within the data management system 220 that match a filter, sort order, or both. For example, the user 185-b of the computing device 105-b may transmit the query 230 that the relationship-based authorization system 205 filter the data management system 220 and return a set of objects that correspond to a keyword indicated within the query 230. However, in some cases, the user 185-b may be unable to view each object that matches the criteria of the query 230 due to a relationship between the user 185-b and a respective object being unavailable. Thus, to ensure that the data management system 220 is secure, the relationship-based authorization system 205 may send the user 185-b a response to the query 230 that indicates a set of objects that the user 185-b has a relationship with and that match the criteria of the query 230.

In some cases, to determine which objects match the criteria of the query 230 and that the user 185-b has access to, the relationship-based authorization system 205 may first search and filter the data management system 220 based on the query 230. As a result, the relationship-based authorization system 205 may obtain a list of objects that satisfy the query 230. Based on obtaining the list of objects associated with the query 230, the relationship-based authorization system 205 may then call a check API endpoint on each object within the list to determine if the user 185-b has a relationship with each respective object. Then, based on the API calls, the relationship-based authorization system 205 may send a list of objects that both satisfy the query 230 and that the user 185-b has a relationship with. In some other cases, the relationship-based authorization system 205 may first obtain a list of identifiers of objects that the user 185-b is capable of accessing (e.g., that the user 185-b has a relationship with). Based on obtaining the list of object identifiers, the relationship-based authorization system 205 may then search the list of object identifiers for objects that satisfy the query 230 of the user 185-b to obtain the list of objects that can be sent back to the user 185-b.

However, in some cases, a quantity of objects that can be returned in response to the query 230 may be relatively high, a quantity of objects of a respective type that the user 185-b has access to may be relatively low, and a percentage of objects within the data management system 220 that the user 185-b may be relatively low. In some other cases, the quantity of objects that can be returned in response to the query 230 may be relatively high, the quantity of objects of a respective type that the user 185-b has access to may be relatively high, and the percentage of objects within the data management system 220 that the user 185-b may relatively low. Further, in some other cases, the quantity of objects that can be returned in response to the query 230 may be relatively high, the quantity of objects of a respective type that the user 185-b has access to may be relatively high, and the percentage of objects within the data management system 220 that the user 185-b may relatively high. In such cases, searching for all the objects that the user 185-b may be capable of accessing or for all the objects in response to the query 230 may be relatively inefficient. Thus, to provide more efficient searches, in accordance with the techniques of the preset disclosure, the relationship-based authorization system 205 may obtain indices of the relationships indicated within the authorization model 225.

The techniques of the present disclosure may describe that when the relationship-based authorization system 205 receives the authorization model 225 from the user 185-a, the relationship-based authorization system 205 may utilize the identification system 210 to identify the relations indicated within the relationship-based authorization system 205. For example, as described elsewhere herein such as with reference to FIG. 3, the authorization model 225 may indicate a set of relations that indicate relationships between users 185 and objects of the data management system 220. Moreover, the set of relations may correspond with a set of relationship tuples that indicates a user 185, a relation, an object, and an optional condition. For example, a respective relationship tuple may indicate that a user 185 Anne (e.g., indicated by a name or a unique identifier) may have an editor relation with a document object. Additionally, or alternatively, the respective relationship tuple may include a condition where the respective relationship tuple indicates a true expression (e.g., a relationship between the user 185 and the object) if the condition is satisfied. Therefore, the relationship tuples may indicate an authorization level of a respective user 185 for a respective object.

Further, the relationship-based authorization system 205 may use the corresponding data management system 215 to generate a set of data messages (e.g., SQL queries) that are associated with the set of relationship tuples indicated within the authorization model 225. The set of data messages may query the data management system 220 to obtain a set of indices that indicate the results of the queries from the set of data messages. For example, a respective data message may be a SQL query to obtain an index of a list of users 185 that have both a viewer relation and an allowed user relation for a respective object. Using the set of indices, the relationship-based authorization system 205 may be capable of determining whether to authorize access to data within the data management system 220. Further, the relationship-based authorization system 205 may generate and obtain the set of indices based on obtaining the results of the set of data messages.

Using the set of indices the relationship-based authorization system 205 may be capable of more efficiently determining a result set of objects to the query 230 from the user 185-b that the user 185-b has access to. For example, the data management system 220 may be a collaborative document storage system where the user 185-b may have access to a relatively large quantity of documents and folders but the overall percentage of documents in the data management system 220 that the user 185-b has access to is relatively low. For example, the data management system 220 may store two million documents (e.g., objects) and the user 185-b may have access to 2,000 documents. However, while such quantity of documents is relatively high, the user 185-b may only have access to 0.1% of the quantity of documents stored in the data management system 220. Thus, to efficiently respond to the query 230 from the user 185-b the relationship-based authorization system 205 may use the identification system 210 and the message generation system 215 to transform the relationship tuples of the authorization model 225 into SQL queries to obtain indices of the relationship tuples of the authorization model 225. Thus, the relationship-based authorization system 205 may use the set of indices to more effectively return the user 185-b with a set of objects that satisfy the query 230 and that the users 185-b has access to.

For example, the user 185-b may send the query 230 to the relationship-based authorization system 205 to receive objects (e.g., documents) with the term “software.” In such examples, there may be 100,000 documents within the data management system 220 that have the term “software,” but the user 185-b may only have access to 100 of such documents. Therefore, by having a set of indices associated with relationships, the relationship-based authorization system 205 may be capable of simplifying the search to documents or folders that one or more indices indicate the user 185-b has a relationship with. For example, a first index may indicate a list of users that have a relationship with a respective group and a second index may indicate a list of documents or folders that members of the respective group have access to. Therefore, the relationship-based authorization system 205 may limit the search to the list of documents, folders, or both that the user 185-b is capable of accessing to reduce the quantity of objects compared to the criteria of the query 230. Thus, the techniques of the present disclosure may provide an increase in efficiency while minimizing the complexity of searching the data management system 220 for objects that the user 185-b has access to in response to the query 230.

To obtain the indices, the relationship-based authorization system 205 may generate a set of data messages associated with the relationships indicated within the relationship-based authorization system 205. In some examples, the set of data messages may be SQL queries used to receive information from the data management system 220 to generate and obtain respective indices. For example, based on identifying the set of relations and the set of relationship tuples indicated within the authorization model 225 via the identification system 210, the relationship-based authorization system 205 may use the message generation system 215 to generate SQL queries to obtain an index (e.g., a table) associated with a respective relationship. In some examples, the message generation system 215 may generate the SQL query based on using an identified relation between an object and a respective user 185. Using the SQL queries, the relationship-based authorization system 205 may then be able to produce or generate a series of materialized views that can be used to obtain or generate an index that can serve queries (e.g., the query 230) in near-real time. Additionally, or alternatively, the message generation system 215 may be an example of a computer program or service that can operate locally on a computing device or can operate a cloud-based service (e.g., a cloud based platform).

Further, in some cases, clients (e.g., end users of the relationship-based authorization system 205) may run or join multiple SQL queries such that indices can be generated for a client-side dataset. Moreover, a SQL abstract syntax tree (AST) may also be used for clients to produce materialized view. For example, by utilizing SQL ASTs, clients may be capable of applying principles of partial evaluation to queries based on pre-known predicates. Partial evaluation may be a technique where a client can generate a simplified query by having queries run with a set of pre-known inputs to reduce the runtime and computation complexity of a query. For example, if a client has a SQL AST that is produced from the authorization model 225, the client can use the relationship-based authorization system 205 to join (e.g., combine) the SQL AST with a client-side AST to create a reduced AST that represents a residual query to be answered. In some examples, such techniques may be used for queries that are related to conditional relationship tuples (e.g., relationship tuples with a condition to be satisfied to make the relationship true). For example, when using such techniques, sub-queries can be reduced or removed based on the value of the attributes provided at runtime of a respective query.

Therefore, once the relationship-based authorization system 205 generates a respective data message (e.g., a SQL query) for a relationship, the relationship-based authorization system 205 may be capable of generating an index of such relationship to increase the efficiency and reliability of queries to the data management system 220. Using such indices, the relationship-based authorization system 205 may also be capable of determining whether a user 185 has access to respective objects or data within the data management system 220. Further descriptions of the techniques of the present disclosure related to the types of relationships that may be indicated via the data messages and the indices obtained from the data messages may be described elsewhere herein, such as with reference to FIG. 3.

FIG. 3 shows an example of an authorization model diagram 300 that supports relationship-based access control authorization model query generation in accordance with aspects of the present disclosure. In some examples, the authorization model diagram 300 may be an example of the authorization model 225 described with reference to FIG. 2. For example, the authorization model diagram 300 may include a representation of an authorization model 225 for a data management system 305. The authorization model 225 may indicate one or more users 310, one or more objects 315, and one or more relations 320 between a respective user 310 and a respective object. Further, the one or more objects 315 may be stored within the data management system 305 and the one or more users 310 may be examples of end users 185 of the data management system 305 or clients of the data management system 305. Additionally, or alternatively, it should be understood by one having ordinary skill in the art that the data management system 305 (e.g., a store), the one or more objects 315 (e.g., the object 315-a, the object 315-b, and the object 315-c), and the one or more users 310 may represent nodes in an authorization model (e.g., an FGA authorization model) and the one or more relations 320 may represent edges of the authorization model. For example, if a user 310 has a viewer relation 320 with a document object 315 (e.g., the object 315-a), the viewer relations 320 may be represented as an edge within the authorization model diagram 300, the source node for the relationship may be the object 315-a and the destination node may be the user 310.

In some examples, as illustrated herein, the authorization model 225 may indicate a set of relations between a set of users and a set of objects. For example, the data management system 305 may include an object 315 that has one or more relations 320 that can be between a user 310 and the document object 315. For example, the authorization model 225 may include definitions for a user 310, an object 315-a and a set of relations 320-a for the object 315-a, an object 315-b and a set of relations 320-b, and an object 315-c and a set of relations 320-c. In some examples, the object 315-a may be representative of a document object and the set of relations 320-a for the object 315-a may include a parent relation, a viewer relation, a read relation, a share relation, an owner relation, a write relation, a change owner relation, or any combination thereof. Further, the object 315-b may be an example of a folder object (e.g., a storage for one or more document objects) and the set of relations 320-b may include a parent relation, a viewer relation, an owner relation, a create file relation, or any combination thereof.

In some cases, the authorization model 225 may indicate definitions for one or more entities. In some examples, the entities may include one or more users 310 that can be entities that relate to one or more respective objects 315. Additionally, or alternatively, the one or more entities may include one or more objects 315 where a relationship 320 between a respective user 310 and a respective object 315 is defined via the authorization model 225 and one or more relationship tuples. Further, the authorization model 225 may indicate relations between users 310 and objects 315 that define a possible relationship between a respective user 310 and a respective object 315. Moreover, a relation definition in the authorization model 225 may indicate one or more conditions for which a relationship 320 is possible. For example, the authorization model 225 may define a viewer relationship 320 for the object 315-a (e.g., a document) stored in the data management system 305 to describe a possible relationship 320 between a user 310 and the object 315-a.

In some cases, the authorization model 225 may define a relationship 320 as a user 310 identifier to object 315 relationship 320 where an identifier of a respective user 310 has a relationship 320 with the object 315-a. In some other cases, the authorization model 225 may define a relationship 320 as an object 315 to object 315 relationship 320 such that a first object 315 has a relationship 320 with a second object 315. For example, the second object 315 may have a child relationship 320 with the first object 15 and the first object 315 may have a parent relationship 320 with the second object 315. In some other cases, the authorization model 225 may define a relationship 320 as a userset (e.g., a set or group of users 310) to object 315 relationship 320. Additionally, or alternatively, the authorization model 225 may define a relationship 320 as an everyone (e.g., all users 310) to object 315 relationship 320. For example, a publicly available object 315 may have an everyone to object 315 relationship 320.

In some examples, the relationship 320 of a respective object 315 may be a direct relationship. For example, the authorization model 225 may indicate that the object 315-b (e.g., a document) can have a direct relationship 320 (e.g., a viewer relationship 320) with a user 310 and an employee (e.g., an entity type defined within the authorization model 225). Thus, in accordance with the techniques of the present disclosure, a relationship-based authorization system may convert such relationship 320 into a SQL query to obtain an index or table of each user 310 or employee that has the viewer relationship 320 for a respective document. In some other examples, a relationship 320 can be computed via a directly rewritten relationship 320. For example, the object 315-b may have a defined editor relationship 320 that indicates that a user 310 may have an editor relationship 320 with the object 315-b. Further, the object 315-b may also have a viewer relationship 320 that indicates that an editor may have a viewer relationship 320 with the object 315-b. Therefore, each user 310 that has an editor relationship 320 with the object 315-b may also have a viewer relationship 320 with the object 315-b. Thus, the relationship-based authorization system may generate a SQL query to generate an index of users 310 that are both editors and viewers of a document by performing a union operation on a first SQL statement related to the viewer relationship 320 and a second SQL statement related to the editor relationship 320.

In another example, the object 315-b may have a set of relationships 320-b that can be computed through different set operations of direct relationships 320. For example, the authorization model 225 may define that a document (e.g., the object 315-b) may have an allowed relationship 320 indicated that a user 310 is allowed to access the document, a restricted relationship 320 indicating that a user 310 is restricted from accessing the document, and an editor relationship 320 indicating that a user 310 is able to edit the document. Further, the object 315-b may also have a first viewer relationship 320 (e.g., a viewerA) that can be a user 310 or a user 310 that has an editor relationship 320 with the document, a second viewer relationship 320 (e.g., a viewerB) that can be a user 310 associated with the first viewer relationship 320 and has an allowed relationship 320 with the document, and a third viewer relationship 320 (e.g., a viewerC) that can be user 310 associated with the first viewer relationship 320 and is not associated with a restricted relationship 320. Thus, based on such relationship 320 definitions within the authorization model 225, the relationship-based authorization system may generate a SQL query to generate an index of users 310 that are associated with the first viewer relationship 320, the second viewer relationship 320, and the third viewer relationship 320.

In some other examples, an object 315 may be associated with nested relationships 320 such as relationships 320 associated with groups of groups. For example, a group object (e.g., the object 315-c) may have an admin relationship 320 and a member relationship 320. In some cases, the authorization model 225 may define member relationship 320 for the group such that users 310 can be members, group members of a different group can be members, and the users 310 with an admin relationship 320 with the group can be members. Therefore, since it may be relatively difficult for the relationship-based authorization system to determine all the members of the group, the relationship-based authorization system may generate a SQL query (e.g., a data message) to obtain an index of a list of users 310 that have a member relationship 320 with a group. In some cases, to obtain such index, the SQL query may include a first SQL statement to obtain a list of users 310 that have an admin relationship 320 with the group, a second SQL statement to obtain a list of users 310 that have a member relationship 320 with the group, and a list of users 310 that are members of a second group that have a member relationship 320 with the group. The result of the first SQL query statement and the result of the second SQL query statement may then be combined (e.g., combined via a union operation) to generate an index of the users 310 that are members of a group.

Additionally, or alternatively, an object 315 may have hierarchical relationships. For example, a folder object 315 (e.g., the object 315-b) may have an editor relationship 320 with a user 310 and a viewer relationship 320 with a user 310 or an editor of the folder (e.g., a user 310 associated with an editor relationship 320 with the object 315-b). Further, a document object 315 (e.g., the object 315-a) may have a parent relationship 320 with the folder object 315 (e.g., the object 315-b is a parent of the object 315-a) and a viewer relationship 320 with a user 310 or a viewer from the parent. Therefore, a user 310 may have a viewer relationship 320 with a document (e.g., the object 315-a) based on having a viewer relationship with the document or having a viewer relationship 320 with the parent folder of the document (e.g., having a viewer relationship 320 with the object 315-b).

Thus, by converting the authorization model 225 into one or more data messages (e.g., SQL queries) in accordance with the techniques of the present disclosure, the relationship-based authorization system may be capable of more efficiently providing results to client searches by obtaining indices as a result of the one or more data messages. For example, the data messages may obtain information from the data management system 305 that can then be formatted into a table or index indicating the results of the data messages. For example, as described herein, the authorization model 225 may define a viewer relationship 320 for a document object 315 (e.g., the object 315-b). In some cases, the viewer relationship 320 may be defined such that a user 310 can view a document if the user 310 is both assigned the viewer relationship 320 for the document and is assigned an allowed relationship 320 for the document. Thus, to view a respective document a user 310 should have both a viewer relationship 320 and an allowed relationship 320.

Therefore, in accordance with the techniques of the present disclosure, the relationship-based authorization system may generate a first SQL query to obtain the users 310 that have an allowed relationship 320 with a document (e.g., the object 315-b) and a second SQL query to obtain the users 310 that have a viewer relationship 320 with the document. Then, the first SQL query and the second SQL query may be joined (e.g., via a SQL JOIN operation) to obtain an index of users 310 that are assigned both the viewer and the allowed relationships 320 and thus are capable of viewing a respective document. In some examples, the relationship-based authorization system may generate one or more SQL queries to obtain an index associated with a nested direct relationship, nested hierarchies, and the link. Thus, for a nested relationship 320, a hierarchical relationship, nested hierarchical relationships 320, and the like that the relationship-based authorization system would be expected to perform multiple lookups in the data management system 305, the set of indices may indicate a respective relationship 320 to reduce the search time. For example, the authorization model 225 may define a viewer relationship 320 as being either a respective user 310 or a viewer of a parent object 315. Thus, opposed to checking both the relationships 320 of a first object 315 and a second object 315 that is a parent to the first object 315, the relationship-based authorization system may generate data messages to query the data management system 305 to obtain an index of both relationships 320 to reduce a quantity of authorization checks.

Therefore, based on obtaining such index, the relationship-based authorization system may use the index to more efficiently provide search results to clients. For example, a client may search within the data management system 305 for a list of documents (e.g., objects 315) associated with a set of criteria or search terms (e.g., a keyword). In response to receiving the request the relationship-based authorization system may perform an API call to a set of indices associated with the relationships 320 indicated within the authorization model 225 to obtain a result to the search that includes objects 315 that the client has access to.

Further, once a respective index is obtained or generated, the relationship-based authorization system may refrain from re-indexing a respective relationship 320 until a change occurs. For example, the relationship-based authorization system may receive an indication of an update to the data management system 305 that can impact one or more indices. In some cases, such updates may include one or more objects 315 being added to the data management system 305, one or more objects 315 being removed from the data management system 305, or both. Thus, based on the update to the data management system 305, the relationship-based authorization system may update the set of indices that indicate the results of the data messages associated with the relationships indicated within the authorization model 225 (e.g., the relations and the relationship tuples indicated). In another example, the relationship-based authorization system may receive an indication of an update to the authorization model 225. For example, one or more users 310 may be added or removed from the authorization model 225, one or more object 315 may be added or removed from the authorization model 225, one or more relations (e.g., relationship 320 definitions) that relate respective users 310 and respective objects 315 may be added or removed, or any combination thereof. Thus, based on the update to the authorization model 225, the relationship-based authorization system may generate updated data messages and the corresponding indices. In some examples, when obtaining an updated index of a respective relationship 320, the results of an SQL query may indicate the changes to an index and the index may be updated accordingly. In some other examples, the results of an SQL query may indicate a full index that may be used as a replacement for a current index of a respective relationship 320.

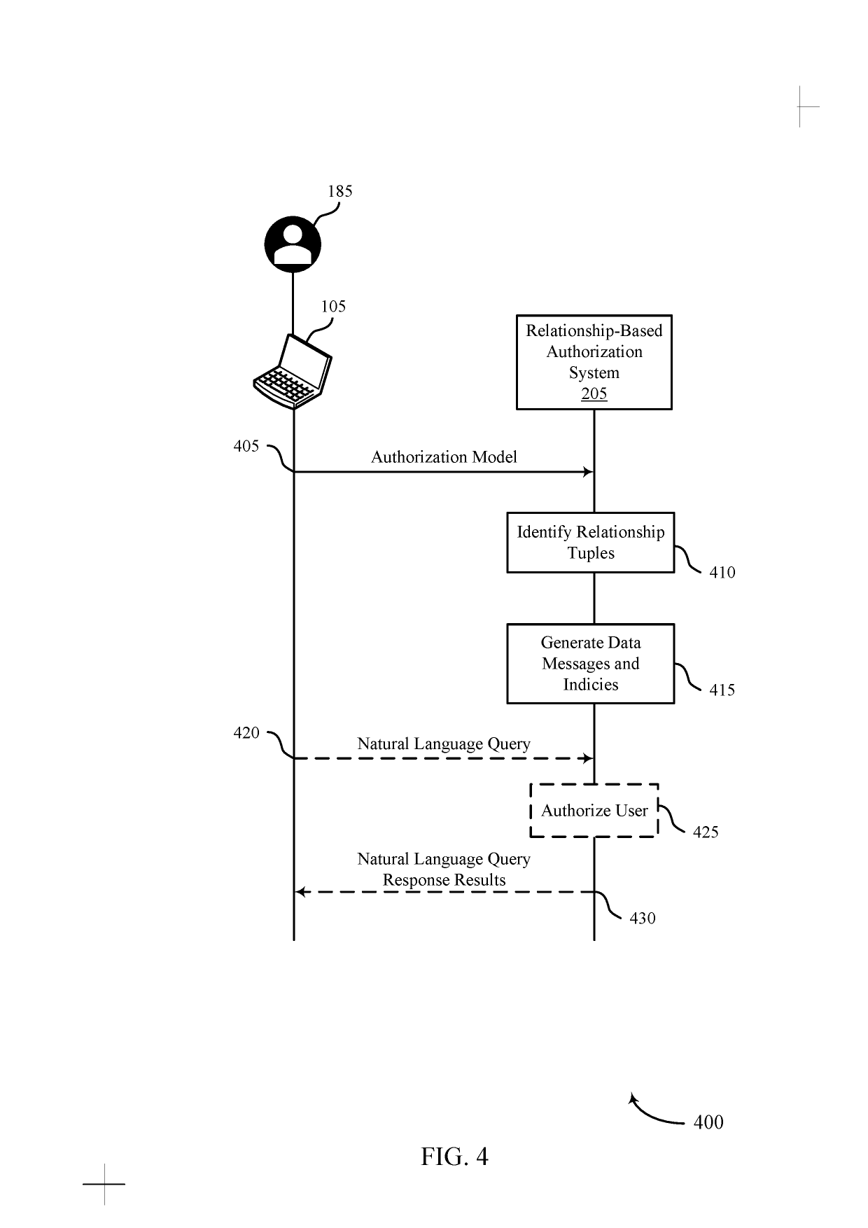

Therefore, by generating data messages that correspond to relationships 320 of the authorization model 225 to obtain indices of the relationships 320, the techniques of the present disclosure may enable a reduction in the latency associated with searching the data management system 305. For example, the techniques of the present disclosure may provide an API for the relationship-based authorization system to use to check a set of indices for search results rather than the entire data management system 305 which may be relatively time consuming and consume a relatively large quantity of computational resources. Thus, the techniques of the present disclosure may enhance the ability of a relationship-based authorization system to use of an authorization model 225 for authorizing clients access to data within a data management system 305, resulting in a more efficient use of time and resources. Further descriptions of the techniques of the present disclosure may be described elsewhere herein, such as with reference to FIG. 4.

FIG. 4 shows an example of a process flow 400 that supports relationship-based access control authorization model query generation in accordance with aspects of the present disclosure. In some examples, the process flow 400 may be implemented by or may implement the computing system 100, the computing system 200, or both. For example, the process flow 400 may include a computing device 105 associated with a user 185 and a relationship-based authorization system 205 which may be examples of devices or services described elsewhere herein with reference to FIGs. 1 and 2.

In the following description of the process flow 400, the operations between the computing device 105 and the relationship-based authorization system 205 may be performed in different orders or at different times. Some operations may also be left out of the process flow 400, or other operations may be added. Although the computing device 105 and the relationship-based authorization system 205 are shown performing the operations of the process flow 400, some aspects of some operations may also be performed by one or more other devices, services, or models described elsewhere herein including with reference to FIG. 1.

At 405, the relationship-based authorization system 205 may receive, from a developer (e.g., the user 185 of the computing device 105) of the relationship-based authorization system 205, an authorization model from a data management system. The authorization model may indicate a set of users and a set of objects. In some examples, the relationship-based authorization system 205 may receive, from a first tenant of a multi-tenant system, a first authorization model for the data management system. The first authorization model may indicate information for authorizing users associated with the first tenant to access one or more objects within the data management system that are associated with the first tenant. Moreover, the data management system may be accessible by one or more tenants of the multi-tenant system, and the first authorization model may include the authorization model. Additionally, or alternatively, the authorization model may be a fine-grained authorization model that is defined via a domain-specific language.

At 410, an identification system of the relationship-based authorization system 205 may identify a set of relations indicating relationships within the authorization model between the set of users and the set of objects. The set of relations may correspond to a set of relationship tuples, where a respective relationship tuple indicates an authorization level of a respective user for a respective object. At 415, a message generation system of the relationship-based authorization system 205 may generate a set of data messages that are associated with the set of relationship tuples indicated within the authorization model. The message generation system may generate the set of data messages to obtain a set of indices that indicate results of the set of data messages. Further, the set of indices may be for authorizing access to data within the data management system.

In some examples, the relationship-based authorization system 205 may obtain the set of indices used for authorizing access to the data within the data management system based on one or more data query operations on the set of data queries. For example, the one or more data query operations may combine the set of data queries. In some other examples, a respective index of the set of indices may indicate a direct relationship between a respective user and a respective object, a computed relationship between the respective user and the respective object, a nested relationship between the respective user and the respective object, a hierarchical relationship between the respective user and the respective object, or any combination thereof. Additionally, or alternatively, the set of data messages may be structured query language (SQL) queries.

At 420, a client (e.g., a user 185 of the computing device 105) may transmit a natural language query to the relationship-based authorization system 205. The natural language query may indicate a request for a user associated with the client to access one or more objects of the set of objects stored within the data management system based on the set of relations indicated within the authorization model. At 425, the client may be authorized to obtain a subset of objects of the set of objects associated with the request that the user is authorized to access based on the set of indices generated via the message generation system. The user may be authorized to access a respective object of the set of objects that is associated with the request based on at least one index of the set of indices indicating that the user has a relationship with the respective object. In some examples, the relationship-based authorization system 205 may transmit a message requesting for an indication of the subset of objects associated with the request of the natural language query via an API associated with the set of indices used for authorizing access within the data management system. Thus, the relationship-based authorization system 205 may receive the subset of objects associated with the request via the API based on the user having a relationship with each object of the subset of objects.

At 430, the subset of objects associated with the request of the natural language query that the user is authorized to access may be transmitted to the client. The transmission may be based on one or more relationships between the user and the subset of objects that the user is authorized to access. Moreover, the relationship-based authorization system 205 may transmit the subset of objects to the client (e.g., a user 185 of the computing device 105) based on receiving the subset of objects via the API. In some cases, the subset of objects may be displayed on the computing device 105 for the client to indicate the response of the natural language query. In some other cases, the relationship-based authorization system 205 may transmit the subset of objects to the computing device 105 for security applications. For example, the subset of objects may be used to evaluate a security decision or to apply a security policy. In such cases, in some examples, the computing device 105 may refrain from displaying the subset of objects to the client (e.g., a user 185) based on the subset of objects being used for security applications.

Further, in some examples, the relationship-based authorization system 205 may receive an indication of an update to the data management system. The update may include adding one or more objects, removing one or more objects, or both. The relationship-based authorization system 205 may then update the set of indices based on receiving the update to the data management system. In some other examples, the relationship-based authorization system 205 may receive an update to the authorization model. The update may include an addition of one or more users, one or more objects, one or more relations relating users and objects, or any combination thereof, a removal of one or more users, one or more objects, one or more relations relating users and objects, or any combination thereof, or both. Thus, the relationship-based authorization system 205 may update the set of data messages and the set of indices based on receiving the update to the authorization model.

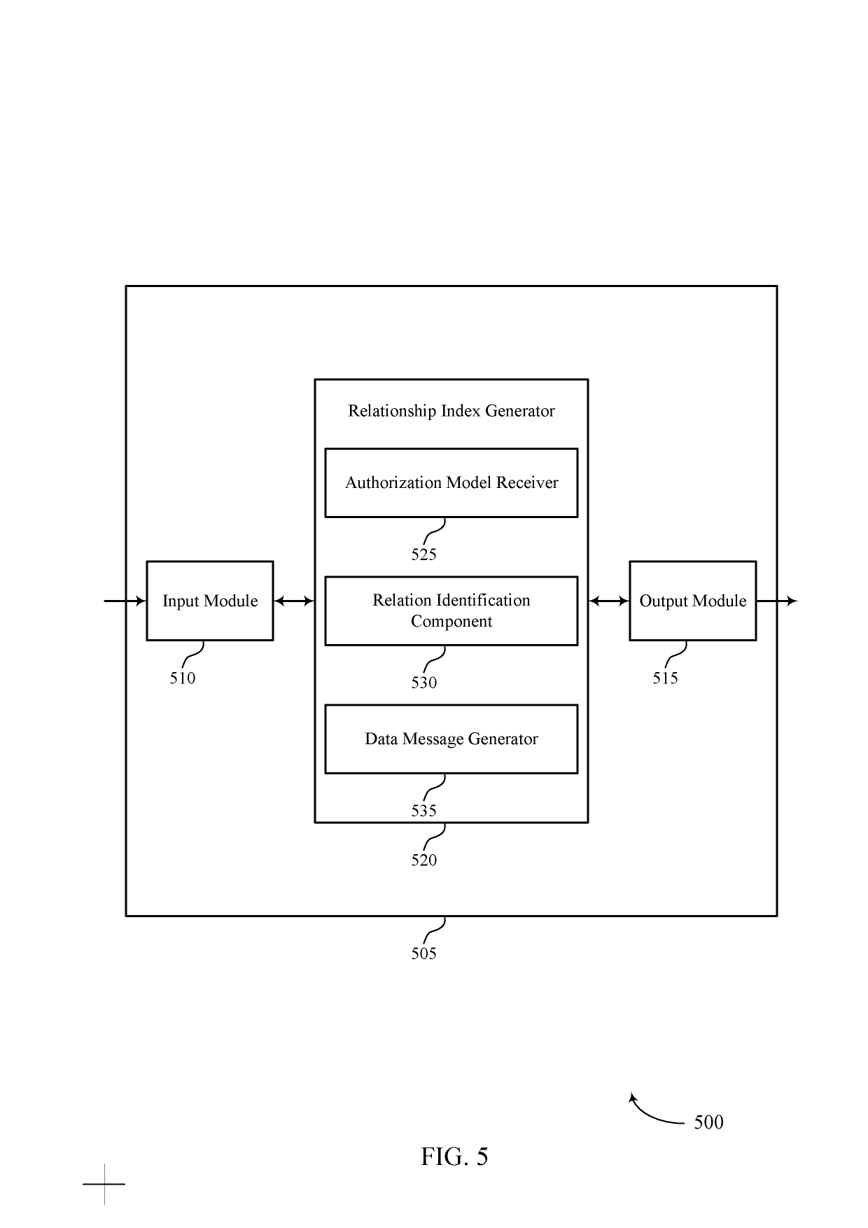

FIG. 5 shows a block diagram 500 of a device 505 that supports relationship-based access control authorization model query generation in accordance with aspects of the present disclosure. The device 505 may include an input module 510, an output module 515, and a relationship index generator 520. The device 505, or one or more components of the device 505 (e.g., the input module 510, the output module 515, the relationship index generator 520), may include at least one processor, which may be coupled with at least one memory, to support the described techniques. Each of these components may be in communication with one another (e.g., via one or more buses).

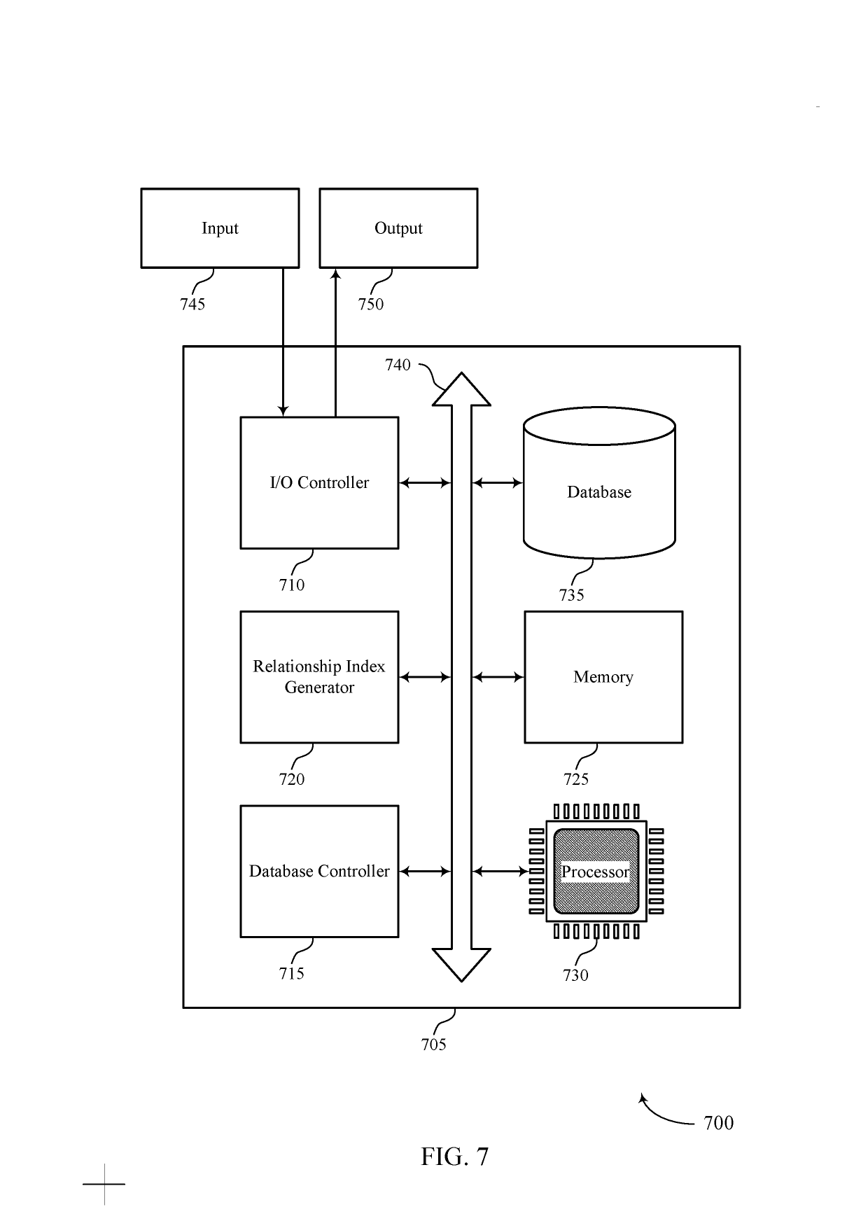

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the relationship index generator 520 to support relationship-based access control authorization model query generation. In some cases, the input module 510 may be a component of an input/output (I/O) controller 710 as described with reference to FIG. 7.

The output module 515 may manage output signals for the device 505. For example, the output module 515 may receive signals from other components of the device 505, such as the relationship index generator 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the relationship index generator 520 may include an authorization model receiver 525, a relation identification component 530, a data message generator 535, or any combination thereof. In some examples, the relationship index generator 520, or various components thereof, may be configured to perform various operations (e.g., receiving, monitoring, transmitting) using or otherwise in cooperation with the input module 510, the output module 515, or both. For example, the relationship index generator 520 may receive information from the input module 510, send information to the output module 515, or be integrated in combination with the input module 510, the output module 515, or both to receive information, transmit information, or perform various other operations as described herein.

The relationship index generator 520 may support indexing permission relationships in a relationship-based authorization system in accordance with examples as disclosed herein. The authorization model receiver 525 may be configured to support receiving, from a developer of the relationship-based authorization system, an authorization model from a data management system, the authorization model indicating a set of users and a set of objects. The relation identification component 530 may be configured to support identifying, via an identification system, a set of relations indicating relationships within the authorization model between the set of users and the set of objects, the set of relations corresponding to a set of relationship tuples, where a respective relationship tuple indicates an authorization level of a respective user for a respective object. The data message generator 535 may be configured to support generating, via a message generation system, a set of data messages that are associated of the set of relationship tuples indicated within the authorization model, the set of data messages being generated to obtain a set of indices that indicate results of the set of data messages, where the set of indices are for authorizing access to data within the data management system.

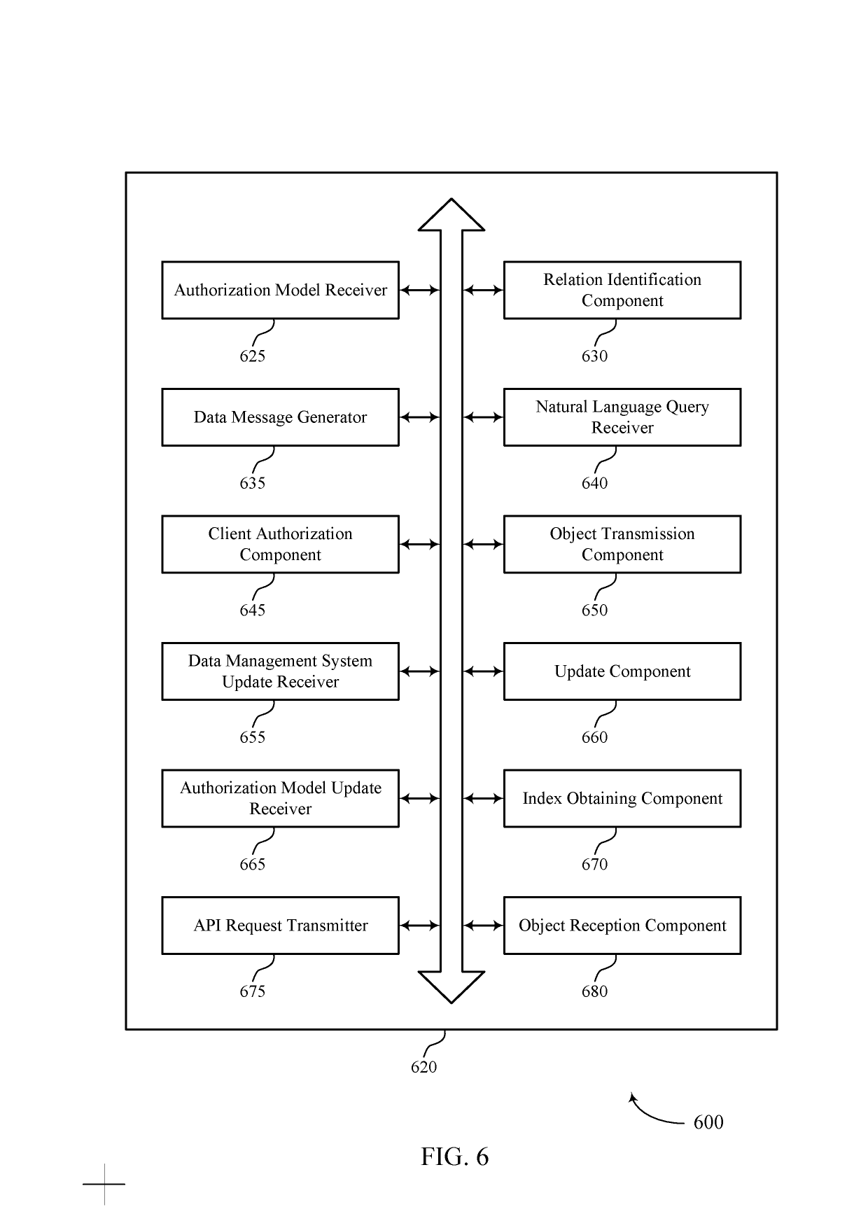

FIG. 6 shows a block diagram 600 of a relationship index generator 620 that supports relationship-based access control authorization model query generation in accordance with aspects of the present disclosure. The relationship index generator 620 may be an example of aspects of a relationship index generator or a relationship index generator 520, or both, as described herein. The relationship index generator 620, or various components thereof, may be an example of means for performing various aspects of relationship-based access control authorization model query generation as described herein. For example, the relationship index generator 620 may include an authorization model receiver 625, a relation identification component 630, a data message generator 635, a natural language query receiver 640, a client authorization component 645, an object transmission component 650, a data management system update receiver 655, an update component 660, an authorization model update receiver 665, an index obtaining component 670, an API request transmitter 675, an object reception component 680, or any combination thereof. Each of these components, or components of subcomponents thereof (e.g., one or more processors, one or more memories), may communicate, directly or indirectly, with one another (e.g., via one or more buses).

The relationship index generator 620 may support indexing permission relationships in a relationship-based authorization system in accordance with examples as disclosed herein. The authorization model receiver 625 may be configured to support receiving, from a developer of the relationship-based authorization system, an authorization model from a data management system, the authorization model indicating a set of users and a set of objects. The relation identification component 630 may be configured to support identifying, via an identification system, a set of relations indicating relationships within the authorization model between the set of users and the set of objects, the set of relations corresponding to a set of relationship tuples, where a respective relationship tuple indicates an authorization level of a respective user for a respective object. The data message generator 635 may be configured to support generating, via a message generation system, a set of data messages that are associated of the set of relationship tuples indicated within the authorization model, the set of data messages being generated to obtain a set of indices that indicate results of the set of data messages, where the set of indices are for authorizing access to data within the data management system.

In some examples, the natural language query receiver 640 may be configured to support receiving, from a client, a natural language query, the natural language query indicating a request for a user associated with the client to access one or more objects of the set of objects that are stored within the data management system based on the set of relations indicated within the authorization model. In some examples, the client authorization component 645 may be configured to support authorizing the client to obtain a subset of objects of the set of objects associated with the request that the user is authorized to access based on the set of indices generated via the message generation system, the user being authorized to access a respective object of the set of objects that is associated with the request based on at least one index of the set of indices indicating that the user has a relationship with the respective object. In some examples, the object transmission component 650 may be configured to support transmitting, to the client, the subset of objects associated with the request of the natural language query that the user is authorized to access based on one or more relationships between the user and the subset of objects that the user are authorized to access.

In some examples, the API request transmitter 675 may be configured to support transmitting, via an API associated with the set of indices used for authorizing access within the data management system, a message requesting for an indication of the subset of objects associated with the request of the natural language query. In some examples, the object reception component 680 may be configured to support receiving, via the application programming interface, the subset of objects associated with the request based on the user having a relationship with each object of the subset of objects, where the subset of objects transmitted to the client based on receiving the subset of objects via the application programming interface.

In some examples, the data management system update receiver 655 may be configured to support receiving an update to the data management system, the update including adding one or more objects, removing one or more objects, or both. In some examples, the update component 660 may be configured to support updating, via the message generation system, the set of indices based on receiving the update to the data management system.

In some examples, the authorization model update receiver 665 may be configured to support receiving an update to the authorization model, the update including an addition of one or more users, one or more objects, one or more relations relating users and objects, or any combination thereof, a removal of one or more users, one or more objects, one or more relations relating users and objects, or any combination thereof, or both. In some examples, the update component 660 may be configured to support updating, via the message generation system, the set of data messages and the set of indices based on receiving the update to the authorization model.

In some examples, to support receiving the authorization model, the authorization model receiver 625 may be configured to support receiving, from a first tenant of a multi-tenant system, a first authorization model for the data management system, the first authorization model indicating information for authorizing users associated with the first tenant to access one or more objects within the data management system that are associated with the first tenant, where the data management system is accessible by one or more tenants of the multi-tenant system, and where the first authorization model includes the authorization model.

In some examples, the set of data messages may include a set of data queries, and the index obtaining component 670 may be configured to support obtaining the set of indices used for authorizing access to the data within the data management system based on one or more data query operations on the set of data queries, the one or more data query operations combining the set of data queries.

In some examples, a respective index of the set of indices indicates a direct relationship between a respective user and a respective object, a computed relationship between the respective user and the respective object, a nested relationship between the respective user and the respective object, a hierarchical relationship between the respective user and the respective object, or any combination thereof.

In some examples, the set of data messages are structured query language (SQL) queries.

In some examples, the authorization model is a fine-grained authorization model that is defined via a domain-specific language.

FIG. 7 shows a diagram of a system 700 including a device 705 that supports relationship-based access control authorization model query generation in accordance with aspects of the present disclosure. The device 705 may be an example of or include components of a device 505 as described herein. The device 705 may include components for bi-directional voice and data communications including components for transmitting and receiving communications, such as a relationship index generator 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting relationship-based access control authorization model query generation). The processor 730 may be an example of a single processor or multiple processors. For example, the device 705 may include one or more processors 730.

The relationship index generator 720 may support indexing permission relationships in a relationship-based authorization system in accordance with examples as disclosed herein. For example, the relationship index generator 720 may be configured to support receiving, from a developer of the relationship-based authorization system, an authorization model from a data management system, the authorization model indicating a set of users and a set of objects. The relationship index generator 720 may be configured to support identifying, via an identification system, a set of relations indicating relationships within the authorization model between the set of users and the set of objects, the set of relations corresponding to a set of relationship tuples, where a respective relationship tuple indicates an authorization level of a respective user for a respective object. The relationship index generator 720 may be configured to support generating, via a message generation system, a set of data messages that are associated of the set of relationship tuples indicated within the authorization model, the set of data messages being generated to obtain a set of indices that indicate results of the set of data messages, where the set of indices are for authorizing access to data within the data management system.

By including or configuring the relationship index generator 720 in accordance with examples as described herein, the device 705 may support techniques for obtaining indices associated with relationships in an authorization model to support improved communication reliability, reduced latency, improved user experience related to reduced processing, reduced power consumption, more efficient utilization of communication resources, and improved utilization of processing capability.

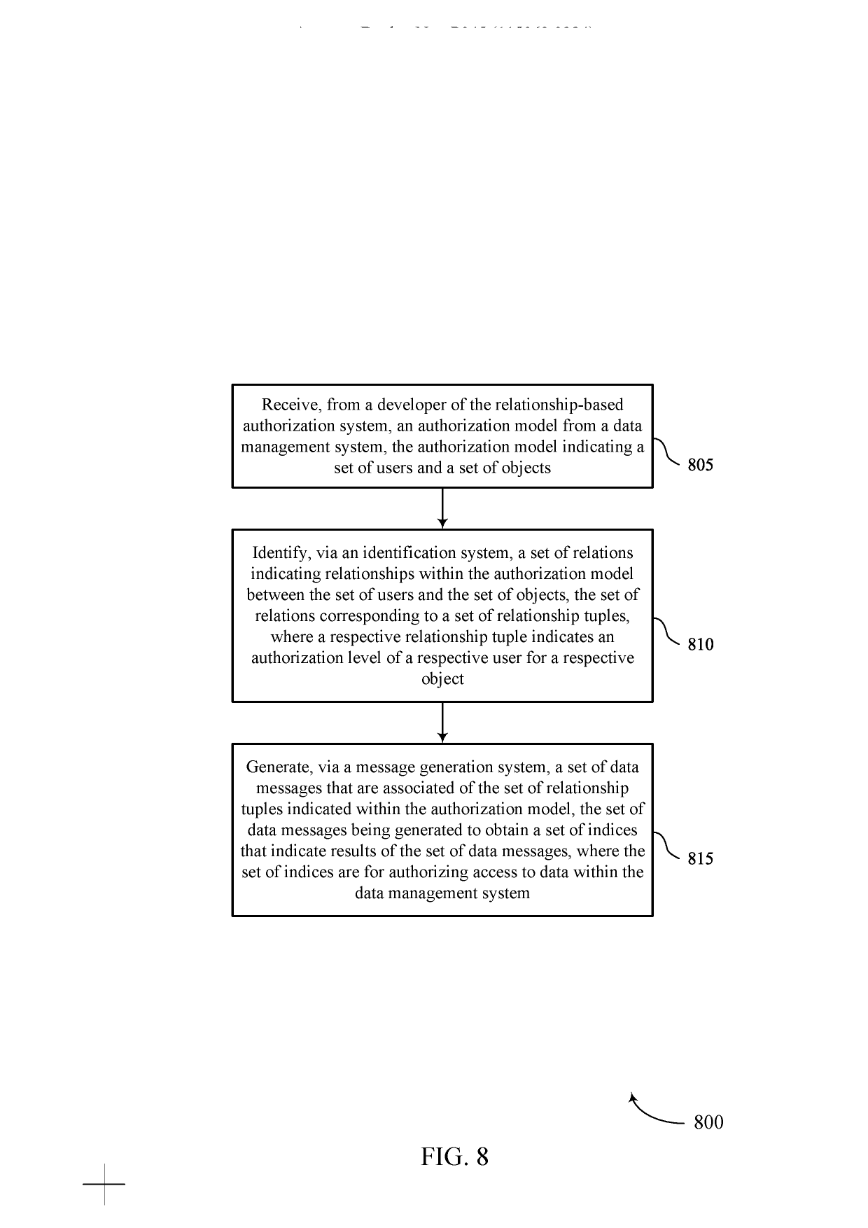

FIG. 8 shows a flowchart illustrating a method 800 that supports relationship-based access control authorization model query generation in accordance with aspects of the present disclosure. The operations of the method 800 may be implemented by a relationship-based authorization system or its components as described herein. For example, the operations of the method 800 may be performed by a relationship-based authorization system as described with reference to FIGs. 1 through 7. In some examples, a relationship-based authorization system may execute a set of instructions to control the functional elements of the relationship-based authorization system to perform the described functions. Additionally, or alternatively, the relationship-based authorization system may perform aspects of the described functions using special-purpose hardware.

At 805, the method may include receiving, from a developer of the relationship-based authorization system, an authorization model from a data management system, the authorization model indicating a set of users and a set of objects. The operations of 805 may be performed in accordance with examples as disclosed herein. In some examples, aspects of the operations of 805 may be performed by an authorization model receiver 625 as described with reference to FIG. 6.

At 810, the method may include identifying, via an identification system, a set of relations indicating relationships within the authorization model between the set of users and the set of objects, the set of relations corresponding to a set of relationship tuples, where a respective relationship tuple indicates an authorization level of a respective user for a respective object. The operations of 810 may be performed in accordance with examples as disclosed herein. In some examples, aspects of the operations of 810 may be performed by a relation identification component 630 as described with reference to FIG. 6.

At 815, the method may include generating, via a message generation system, a set of data messages that are associated of the set of relationship tuples indicated within the authorization model, the set of data messages being generated to obtain a set of indices that indicate results of the set of data messages, where the set of indices are for authorizing access to data within the data management system. The operations of 815 may be performed in accordance with examples as disclosed herein. In some examples, aspects of the operations of 815 may be performed by a data message generator 635 as described with reference to FIG. 6.

The following provides an overview of aspects of the present disclosure:

Aspect 1: A method for indexing permission relationships in a relationship-based authorization system, comprising: receiving, from a developer of the relationship-based authorization system, an authorization model from a data management system, the authorization model indicating a set of users and a set of objects; identifying, via an identification system, a set of relations indicating relationships within the authorization model between the set of users and the set of objects, the set of relations corresponding to a set of relationship tuples, wherein a respective relationship tuple indicates an authorization level of a respective user for a respective object; and generating, via a message generation system, a set of data messages that are associated of the set of relationship tuples indicated within the authorization model, the set of data messages being generated to obtain a set of indices that indicate results of the set of data messages, wherein the set of indices are for authorizing access to data within the data management system.

Aspect 2: The method of aspect 1, further comprising: receiving, from a client, a natural language query, the natural language query indicating a request for a user associated with the client to access one or more objects of the set of objects that are stored within the data management system based at least in part on the set of relations indicated within the authorization model; authorizing the client to obtain a subset of objects of the set of objects associated with the request that the user is authorized to access based at least in part on the set of indices generated via the message generation system, the user being authorized to access a respective object of the set of objects that is associated with the request based at least in part on at least one index of the set of indices indicating that the user has a relationship with the respective object; and transmitting, to the client, the subset of objects associated with the request of the natural language query that the user is authorized to access based at least in part on one or more relationships between the user and the subset of objects that the user are authorized to access.

Aspect 3: The method of aspect 2, further comprising: transmitting, via an API associated with the set of indices used for authorizing access within the data management system, a message requesting for an indication of the subset of objects associated with the request of the natural language query; and receiving, via the application programming interface, the subset of objects associated with the request based at least in part on the user having a relationship with each object of the subset of objects, wherein the subset of objects transmitted to the client based at least in part on receiving the subset of objects via the application programming interface.

Aspect 4: The method of any of aspects 1 through 3, further comprising: receiving an update to the data management system, the update comprising adding one or more objects, removing one or more objects, or both; and updating, via the message generation system, the set of indices based at least in part on receiving the update to the data management system.

Aspect 5: The method of any of aspects 1 through 4, further comprising: receiving an update to the authorization model, the update comprising an addition of one or more users, one or more objects, one or more relations relating users and objects, or any combination thereof, a removal of one or more users, one or more objects, one or more relations relating users and objects, or any combination thereof, or both; and updating, via the message generation system, the set of data messages and the set of indices based at least in part on receiving the update to the authorization model.

Aspect 6: The method of any of aspects 1 through 5, wherein receiving the authorization model comprises: receiving, from a first tenant of a multi-tenant system, a first authorization model for the data management system, the first authorization model indicating information for authorizing users associated with the first tenant to access one or more objects within the data management system that are associated with the first tenant, wherein the data management system is accessible by one or more tenants of the multi-tenant system, and wherein the first authorization model comprises the authorization model.

Aspect 7: The method of any of aspects 1 through 6, wherein the set of data messages comprise a set of data queries and the method further comprises: obtaining the set of indices used for authorizing access to the data within the data management system based at least in part on one or more data query operations on the set of data queries, the one or more data query operations combining the set of data queries.

Aspect 8: The method of any of aspects 1 through 7, wherein a respective index of the set of indices indicates a direct relationship between a respective user and a respective object, a computed relationship between the respective user and the respective object, a nested relationship between the respective user and the respective object, a hierarchical relationship between the respective user and the respective object, or any combination thereof.

Aspect 9: The method of any of aspects 1 through 8, wherein the set of data messages are structured query language (SQL) queries.

Aspect 10: The method of any of aspects 1 through 9, wherein the authorization model is a fine-grained authorization model that is defined via a domain-specific language.

Aspect 11: An apparatus for indexing permission relationships in a relationship-based authorization system, comprising one or more memories storing processor-executable code, and one or more processors coupled with the one or more memories and individually or collectively operable to execute the processor-executable code to cause the apparatus to perform a method of any of aspects 1 through 10.

Aspect 12: An apparatus for indexing permission relationships in a relationship-based authorization system, comprising at least one means for performing a method of any of aspects 1 through 10.

Aspect 13: A non-transitory computer-readable medium storing code for indexing permission relationships in a relationship-based authorization system, the code comprising instructions executable by one or more processors to perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for indexing permission relationships in a relationship-based authorization system, comprising:
receiving, from a developer of the relationship-based authorization system, an authorization model from a data management system, the authorization model indicating a set of users and a set of objects;
identifying, via an identification system, a set of relations indicating relationships within the authorization model between the set of users and the set of objects, the set of relations corresponding to a set of relationship tuples, wherein a respective relationship tuple indicates an authorization level of a respective user for a respective object; and
generating, via a message generation system, a set of data messages that are associated of the set of relationship tuples indicated within the authorization model, the set of data messages being generated to obtain a set of indices that indicate results of the set of data messages, wherein the set of indices are for authorizing access to data within the data management system.

2. The method of claim 1, further comprising:
receiving, from a client, a natural language query, the natural language query indicating a request for a user associated with the client to access one or more objects of the set of objects that are stored within the data management system based at least in part on the set of relations indicated within the authorization model;
authorizing the client to obtain a subset of objects of the set of objects associated with the request that the user is authorized to access based at least in part on the set of indices generated via the message generation system, the user being authorized to access a respective object of the set of objects that is associated with the request based at least in part on at least one index of the set of indices indicating that the user has a relationship with the respective object; and
transmitting, to the client, the subset of objects associated with the request of the natural language query that the user is authorized to access based at least in part on one or more relationships between the user and the subset of objects that the user are authorized to access.

3. The method of claim 2, further comprising:
transmitting, via an application programming interface associated with the set of indices used for authorizing access within the data management system, a message requesting for an indication of the subset of objects associated with the request of the natural language query; and
receiving, via the application programming interface, the subset of objects associated with the request based at least in part on the user having a relationship with each object of the subset of objects, wherein the subset of objects transmitted to the client based at least in part on receiving the subset of objects via the application programming interface.

4. The method of claim 1, further comprising:
receiving an update to the data management system, the update comprising adding one or more objects, removing one or more objects, or both; and
updating, via the message generation system, the set of indices based at least in part on receiving the update to the data management system.

5. The method of claim 1, further comprising:
receiving an update to the authorization model, the update comprising an addition of one or more users, one or more objects, one or more relations relating users and objects, or any combination thereof, a removal of one or more users, one or more objects, one or more relations relating users and objects, or any combination thereof, or both; and
updating, via the message generation system, the set of data messages and the set of indices based at least in part on receiving the update to the authorization model.

6. The method of claim 1, wherein receiving the authorization model comprises:
receiving, from a first tenant of a multi-tenant system, a first authorization model for the data management system, the first authorization model indicating information for authorizing users associated with the first tenant to access one or more objects within the data management system that are associated with the first tenant, wherein the data management system is accessible by one or more tenants of the multi-tenant system, and wherein the first authorization model comprises the authorization model.

7. The method of claim 1, wherein the set of data messages comprise a set of data queries and the method further comprises:
obtaining the set of indices used for authorizing access to the data within the data management system based at least in part on one or more data query operations on the set of data queries, the one or more data query operations combining the set of data queries.

8. The method of claim 1, wherein a respective index of the set of indices indicates a direct relationship between a respective user and a respective object, a computed relationship between the respective user and the respective object, a nested relationship between the respective user and the respective object, a hierarchical relationship between the respective user and the respective object, or any combination thereof.

9. The method of claim 1, wherein the set of data messages are structured query language (SQL) queries.

10. The method of claim 1, wherein the authorization model is a fine-grained authorization model that is defined via a domain-specific language.

11. An apparatus for indexing permission relationships in a relationship-based authorization system, comprising:
one or more memories storing processor-executable code; and
one or more processors coupled with the one or more memories and individually or collectively operable to execute the processor-executable code to cause the apparatus to:
receive, from a developer of the relationship-based authorization system, an authorization model from a data management system, the authorization model indicating a set of users and a set of objects;
identify, via an identification system, a set of relations indicating relationships within the authorization model between the set of users and the set of objects, the set of relations corresponding to a set of relationship tuples, wherein a respective relationship tuple indicates an authorization level of a respective user for a respective object; and
generate, via a message generation system, a set of data messages that are associated of the set of relationship tuples indicated within the authorization model, the set of data messages being generated to obtain a set of indices that indicate results of the set of data messages, wherein the set of indices are for authorizing access to data within the data management system.

12. The apparatus of claim 11, wherein the one or more processors are individually or collectively further operable to execute the processor-executable code to cause the apparatus to:
receive, from a client, a natural language query, the natural language query indicating a request for a user associated with the client to access one or more objects of the set of objects that are stored within the data management system based at least in part on the set of relations indicated within the authorization model;
authorize the client to obtain a subset of objects of the set of objects associated with the request that the user is authorized to access based at least in part on the set of indices generated via the message generation system, the user being authorized to access a respective object of the set of objects that is associated with the request based at least in part on at least one index of the set of indices indicating that the user has a relationship with the respective object; and
transmit, to the client, the subset of objects associated with the request of the natural language query that the user is authorized to access based at least in part on one or more relationships between the user and the subset of objects that the user are authorized to access.

13. The apparatus of claim 11, wherein the one or more processors are individually or collectively further operable to execute the processor-executable code to cause the apparatus to:
receive an update to the data management system, the update comprising adding one or more objects, removing one or more objects, or both; and
update, via the message generation system, the set of indices based at least in part on receiving the update to the data management system.

14. The apparatus of claim 11, wherein the one or more processors are individually or collectively further operable to execute the processor-executable code to cause the apparatus to:
receive an update to the authorization model, the update comprising an addition of one or more users, one or more objects, one or more relations relating users and objects, or any combination thereof, a removal of one or more users, one or more objects, one or more relations relating users and objects, or any combination thereof, or both; and
update, via the message generation system, the set of data messages and the set of indices based at least in part on receiving the update to the authorization model.

15. The apparatus of claim 11, wherein, to receive the authorization model, the one or more processors are individually or collectively operable to execute the processor-executable code to cause the apparatus to:
receive, from a first tenant of a multi-tenant system, a first authorization model for the data management system, the first authorization model indicating information for authorizing users associated with the first tenant to access one or more objects within the data management system that are associated with the first tenant, wherein the data management system is accessible by one or more tenants of the multi-tenant system, and wherein the first authorization model comprises the authorization model.

16. A non-transitory computer-readable medium storing code for indexing permission relationships in a relationship-based authorization system, the code comprising instructions executable by one or more processors to:
receive, from a developer of the relationship-based authorization system, an authorization model from a data management system, the authorization model indicating a set of users and a set of objects;
identify, via an identification system, a set of relations indicating relationships within the authorization model between the set of users and the set of objects, the set of relations corresponding to a set of relationship tuples, wherein a respective relationship tuple indicates an authorization level of a respective user for a respective object; and
generate, via a message generation system, a set of data messages that are associated of the set of relationship tuples indicated within the authorization model, the set of data messages being generated to obtain a set of indices that indicate results of the set of data messages, wherein the set of indices are for authorizing access to data within the data management system.

17. The non-transitory computer-readable medium of claim 16, wherein the instructions are further executable by the one or more processors to:
receive, from a client, a natural language query, the natural language query indicating a request for a user associated with the client to access one or more objects of the set of objects that are stored within the data management system based at least in part on the set of relations indicated within the authorization model;
authorize the client to obtain a subset of objects of the set of objects associated with the request that the user is authorized to access based at least in part on the set of indices generated via the message generation system, the user being authorized to access a respective object of the set of objects that is associated with the request based at least in part on at least one index of the set of indices indicating that the user has a relationship with the respective object; and
transmit, to the client, the subset of objects associated with the request of the natural language query that the user is authorized to access based at least in part on one or more relationships between the user and the subset of objects that the user are authorized to access.

18. The non-transitory computer-readable medium of claim 16, wherein the instructions are further executable by the one or more processors to:
receive an update to the data management system, the update comprising adding one or more objects, removing one or more objects, or both; and
update, via the message generation system, the set of indices based at least in part on receiving the update to the data management system.

19. The non-transitory computer-readable medium of claim 16, wherein the instructions are further executable by the one or more processors to:
receive an update to the authorization model, the update comprising an addition of one or more users, one or more objects, one or more relations relating users and objects, or any combination thereof, a removal of one or more users, one or more objects, one or more relations relating users and objects, or any combination thereof, or both; and
update, via the message generation system, the set of data messages and the set of indices based at least in part on receiving the update to the authorization model.

20. The non-transitory computer-readable medium of claim 16, wherein the instructions to receive the authorization model are executable by the one or more processors to:
receive, from a first tenant of a multi-tenant system, a first authorization model for the data management system, the first authorization model indicating information for authorizing users associated with the first tenant to access one or more objects within the data management system that are associated with the first tenant, wherein the data management system is accessible by one or more tenants of the multi-tenant system, and wherein the first authorization model comprises the authorization model.
